(19) United States
(12) Patent Application Publication
(10) Pub. No.: US 2016/0275526 A1
(43) Pub. Date: Sep. 22, 2016

(54) Time Based Anomaly Analysis in Digital Documents

(71) Applicant: Pixai US Patent Holdco, LLC, Loveland, CO (US)

(72) Inventor: Vlatko Becanovic, Bern (CH)

(21) Appl. No.: 14/664,613

(22) Filed: Mar. 20, 2015

(51) Int. Cl. G06Q 30/00; G06F 17/30

(52) U.S. Cl. CPC G06Q 30/0185; G06F 17/30011

(57) ABSTRACT

A document metadata analysis system may analyze a digital document's metadata structure to identify consistencies or inconsistencies in the metadata. The analysis system may further compare a group of documents to identify consistencies or inconsistencies across multiple documents. The analysis system may analyze a metadata structure to identify time, date, and place parameters, then attempt to normalize the time and date parameters to a consistent time, such as local time. Various clustering techniques may be used to group parameters together, then populate metadata time, date and time-zone offset parameters that may be unpopulated. Seeding techniques may be used to populate the some parameters with a probable parameter value, then various clustering techniques may be used to further populate the parameter values. The metadata from multiple documents may be utilized for an additional seeding mechanism and may be compared against each other to further populate unpopulated parameter values.

### BACKGROUND

Digital photos are taken every day at an ever increasing rate. Even the lowest cost mobile telephones are equipped with a camera, as well as many handheld cameras and other photographic devices.

Photos can be used as evidence in private and legal transactions or simply stored and searched according to their time and date information. In an example of a private transaction, an insurance company may request a set of photos of a loss by a claimant as evidence to support an insurance claim. In an example of a legal transaction, a set of photographs may be used by police investigators to determine who performed a crime.

Photos are easily manipulated and changes. Some photo applications have various filtering and distortion effects that may enhance photos that may be shared within a social network. Some photo applications may have very sophisticated editing mechanisms that may be used to severely change the image in ways that may be difficult to detect.

Digital photos are merely one example of a digital document that are used in transactions and for which changes and manipulations are of interest for individuals, corporations, and governmental or legal entities.

### SUMMARY

A document metadata analysis system may analyze a digital document's metadata structure to identify consistencies or inconsistencies in the metadata. The analysis system may further compare a group of documents to identify consistencies or inconsistencies across multiple documents. The analysis system may analyze a metadata structure to identify time, date, and place parameters, then attempt to normalize the time and date parameters to a consistent time, such as local time. Various clustering techniques may be used to group parameters together, then populate metadata time, date and time-zone offset parameters that may be unpopulated. Seeding techniques may be used to populate the some parameters with a probable parameter value, then various clustering techniques may be used to further populate the parameter values. The metadata from multiple documents may be utilized for an additional seeding mechanism and may be compared against each other to further populate unpopulated parameter values. The resulting metadata structure for each single document may be populated by using seeding information from single or multiple documents and may then be analyzed for inconsistencies, which may be an indicator of fraud.

### BRIEF DESCRIPTION OF THE DRAWINGS

In the drawings,

FIG. 1 is a diagram illustration of an embodiment showing a method for generating time based fraud and other analyses.

FIG. 2 is a diagram illustration of an embodiment showing a network environment with devices that may interact in a document analysis system.

FIG. 3 is a flowchart illustration of an embodiment showing a method for identifying metadata snippets.

FIG. 4 is a flowchart illustration of an embodiment showing a method for identifying time-related metadata parameters.

FIG. 5 is a flowchart illustration of an embodiment showing a method for analyzing a single document.

FIG. 6 is a flowchart illustration of an embodiment showing a method for analyzing a group of documents.

FIG. 7 is a flowchart illustration of an embodiment showing a method for determining a document's provenance.

FIG. 8 is a flowchart illustration of an embodiment showing a method for verifying a document's provenance.

FIG. 9 is a flowchart illustration of an embodiment showing a method for analyzing and overriding time or time zone values.

### DETAILED DESCRIPTION

Fraud and Anomaly Analysis in Digital Documents

A digital document analysis system may analyze the metadata of one or more documents to populate a metadata structure for the documents, then determine likely time and data values for various metadata parameters. The populated metadata structure may be further analyzed for inconsistencies as a single document or by analyzing multiple documents to identify inconsistencies across the documents.

The digital document may be an image, video, audio, text-based document, or other media. In some cases, the digital document may be executable code, databases, or other documents that may not be human-consumable. Throughout this document, a canonical example of a digital image is used to illustrate the process of analyzing a digital document. However, the process may be applied to any other digital documents.

Many digital documents may contain metadata that defines various parameters about the documents. In an example of a digital image, these metadata may define, for example, the camera make and model, the exposure and other parameters about the image capture settings. The metadata often include time-related information such as time and date information and time-zone offset information. In some cases, place information may be present from which the time-zone offset can be inferred. In many cases, there may be multiple time-related parameters for a single image, as well as some parameters from which time, date and time-zone offset may be inferred.

Multiple time-related parameters may be included in a single image. For example, a camera may create a time and date value when the image was captured, and a filter or editing tool may add a second time and date value when the image is modified. A third time and date stamp may be added when the image may be processed such as when the image may be uploaded to a website and compressed or resized. An accompanying time-zone offset value might, or might not be registered together with the time and date parameter value during such an event.

In many instances, a document's time-related metadata may originate from different devices or services, each of which may have different time and date settings. The time-related metadata may be added by a device or service that originates a document, devices or services that subsequently process or manipulate the document, as well as devices or services that store and transmit the document. Each of these various devices may have grossly varying time and date parameters.

For example, a camera or other device may have a time and date that may be manually configured by a user. Such a time and date setting may be improperly set, not set at all, or may be offset from a precise time standard. When a time-related setting is not configured by a user, the time and date may reflect an elapsed time from when the device was first powered on or when batteries where installed. Such a time and date setting may be incorrect but still may be useful when performing fraud analysis of a document created by the device, for example.

Similarly, the time and date settings for a device may be offset from a precise time standard. In cases where the user inputs the time and date settings, the user may not have access to a standard and precise time and date during the setting procedure, and even when such a precise time and date are available, there may be an inherent time difference due to the setting procedure. In some cases, a user may establish a time and date setting for a device, then carry the device to another time zone, such as when a user takes a camera on a vacation. Often, a user may forget to reset the time and date settings for the device when changing location. In a similar situation, a user may set the time and date under Daylight Saving Time, then forget to reset the time and date when normal time resumes.

Some metadata parameters may include a notion of “carry time”, which may be an elapsed time from some event. In the example of a camera for which a user has not set the time and date parameters, the time and date information may reflect the elapsed time from when batteries may have been installed or from a pre-set factory time.

Carry time may be estimated or analyzed from any metadata parameter that has a notion of a counter. An example of counter parameters may be as simple as a file naming convention, where each file may be named consecutively. Such a parameter may have a very coarse mapping to time and date. Another example may be provided by a service that performs some type of processing of a document, such as a network that uploads a sequence of files. The network may store a consecutive counter of uploaded bytes for that day, which may be used as a proxy for time. Many devices and services may have metadata parameters that may have been created for various reasons, such as internal programming testing or monitoring, some of which may operate as a counter and may give a notion of time and date even though the metadata parameters may not have been created for time and date analysis.

Some metadata parameters may include a notion of “place carrying” information which could be textual information that describes a geographic location, such as a city, region or country, or information, such as country and language locales. Such information may be an indicator of a time zone. In some cases, such metadata parameters may be strongly indicative of a time zone and may have more weight than other metadata parameters for a time zone.

A document may have other metadata from which time and date may be inferred. For example, some image capture systems may have Global Positioning System (GPS) receivers or other location detection systems. Many such systems may include GPS readings or other location information as metadata on an image. These metadata often can be decoded and analyzed to determine the time-zone offset values and become a valid seed for local time and date calculations.

GPS data may or may not be precisely accurate. Some devices may store GPS metadata that includes time and date information, while other devices may store only location information from GPS but not include time and date information. GPS data may suffer from inaccuracies when a device is used indoors. For example, a user may operate a device outdoors or near a window when a GPS connection may be established, then may turn off the device and transport the device to an indoor location where the device may be used. Under such circumstances the GPS location data may be retrieved from the IP address of the device or from the IP address of the network provider used and then location information is less accurate, wholly inaccurate or can be missing altogether.

In another example, a user may have the option to disable GPS location information. In such cases location information can be estimated from time-zone offset parameters that are in the same metadata and other place carrying information from the same image or other images that belong to the same event.

For a given document, a metadata structure may be constructed of the available metadata parameters. In some cases, such as where multiple images may be compared against each other, the metadata structure may be a superset of all available metadata parameters gathered from all of the analyzed images. In some cases, the metadata structure may be further populated with additional time-related parameters that may not be found in the original metadata structures but that will add to the consistency of time-related parameters.

The metadata structure may be grouped such that parameters within the same group may have the same time and date. For example, parameters relating to a photo filter or manipulation may be grouped together such that the time and date of the manipulation may be assumed or associated to the parameters within the group.

Some parameters, such as GPS or other location information, may have imbedded time, date and location information. Such parameters may be analyzed and used to populate the metadata structure.

The metadata structure may be analyzed to identify inconsistencies. An inconsistency may arise when the time and date parameters do not correlate with each other. For example, an inconsistency may be flagged when an editing process may have a time and date value that is earlier than the image creation time and date, or when a time and date derived from GPS or other location data may be much different than the image creation time and date.

In some cases, a time and date parameter may be given priority and used to override other time and date parameters. For example, a time and date value derived from a GPS location may be considered more reliable than a camera's internal time and date settings. In such a case, when a time value can be derived from the GPS location, that time and date value may override the time and date value for the image creation.

An analysis may examine a single document or multiple documents together. When multiple documents may be available, the metadata structures of the documents may be examined to identify parameters that appear to reflect time-related information, such as time carrying and place carrying parameters, as well as a superset of metadata parameters. Multiple documents may also be used to cross-seed parameter values from one document to another as part of a clustering analysis. Multiple documents may also be used to compare results between documents to identify abnormalities, which may indicate fraud, for example.

Metadata analysis may be used to clean up or correct metadata structure for a document. Such clean up may determine a likely time and date for a document and may remove inconsistent or incomplete data from the metadata structure. Such a scenario may be useful for processing a photo album, for example. A user may have image documents from many sources, which may have been stored, processed, or handled by many different storage systems or post processors. By analyzing and determining a time parameter with a high confidence, the photos in the photo album may be arranged chronologically.

Throughout this specification and claims, the terms “timestamp” and “time” parameters are used interchangeably to refer to parameters that capture a time-related parameter. In many instances, these parameters may also include a date parameter and in some cases may only include a date reference without time of day.

Throughout this specification, like reference numbers signify the same elements throughout the description of the figures.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

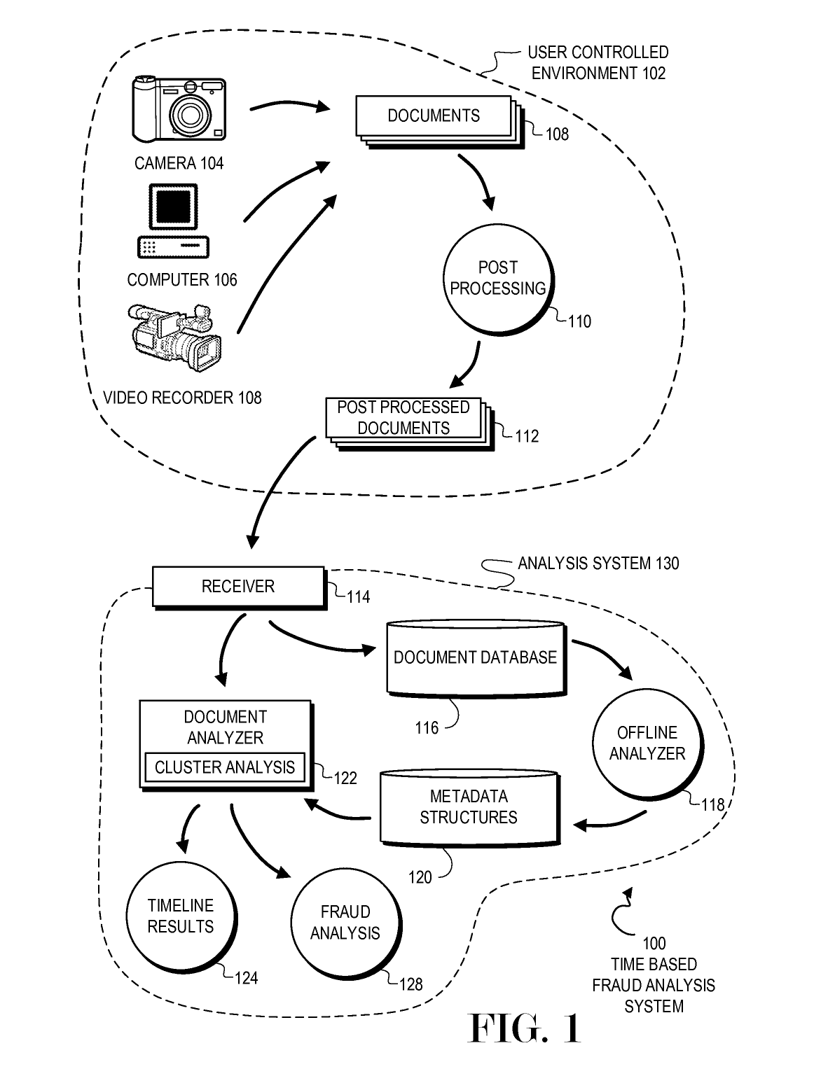

FIG. 1 is an illustration showing an embodiment 100 showing analysis of electronic documents. The process illustrates document creation and handling inside a user controlled environment 102 as well as an analysis system 130 that may analyze a document or set of documents to do time-zone offset normalization and to detect fraud or other analysis.

The user controlled environment 102 may illustrate the normal operating environment of an electronic document. A document 108 may be created by a camera 104, computer 106, video recorder 108, or any other device. The documents 108 may undergo various post processing 110 and result in post processed documents 112.

Each time a document may be created or modified, the metadata associated with the document may be created or altered. The metadata may be any data associated with the document. In many cases, the metadata may be stored with the document and may or may not be visible to a user. In a simple example, a filename may be one form of metadata that a user may be able to view, while a model number of a camera used to generate an image may be stored in the file but not generally seen by a user.

Some metadata may be available separately from a document file. For example, a file size may be calculated by a file system and may or may not be stored in the document file. In some cases, a file system or other database may create metadata that may be related to a document file, and such metadata may be stored separately from the document file.

Many documents may have a metadata structure that may be artifacts of a device or software that may create, modify, store, transport, or otherwise handle the document. As each device or software handles the document, metadata may be added in a particular way, and these artifacts may be clues as to how the document underwent post processing 110.

Various methods of post processing 110 may include modifying the document, such as editing text, applying a filter to an image, rotating or cropping an image, storing the document on a device or cloud service, or other processing. In some cases, the post processing 110 may be innocuous and even helpful, by correcting exposure of an image, editing a video file, or making updates to a text document. In other cases, the post processing 110 may be nefarious, such as “photoshopping” an image to change the picture, surreptitiously editing a contract document to change terms, editing out a portion of a video, or even directly modifying time and date values in metadata without changing the bulk of the document.

Changes to a document's metadata may occur intentionally or unintentionally. In many cases, even when a document may be nefariously edited or changed, the metadata structure may reflect the change even when the person doing the modification may have taken pains to try to hide the change. The analysis of an entire metadata structure may reveal such fraud in many cases, as the metadata structure may be inconsistent with the purported provenance of the document.

An analysis system 130 may examine documents to determine several things about the documents. In many use cases, the analysis system 130 may perform fraud analysis 128. The fraud analysis 128 may determine a likelihood of fraud, which may be useful when the authenticity of a document may be relied upon for financial transactions, for example. A document analyzer 122 may be able to determine a likely time of creation or modification of a document, and may be able to establish a time and date for the document when such information may not be readily available. Other analysis may include provenance analysis that may determine a likelihood that a document originated and was processed in an asserted manner.

The analysis system 130 may have a receiver 114 that may receive a document to be processed. The document may be placed in a document database 116.

An offline analyzer 118 may process one or more documents from the document database 116 to identify metadata structures 120. The metadata structures 120 may be classified together using clustering analysis or other analyses to generate metadata snippets or sections. Each of the metadata sections may reflect some information that may be inferred from the metadata.

The analyzed metadata structures 120 may contain groups of metadata elements that may be organized in specific ways or may operate in specific ways that may permit conclusions to be drawn from the metadata. For example, a specific manufacturer of cameras or video recorders may include a specified set of metadata parameters in each file created by a device. The metadata structures may identify the data collected by each device or software, the arrangement or sequencing of the metadata, the behavior of the metadata, or any other characteristic of metadata from which an inference may be made.

The metadata may include technical metadata, descriptive metadata, and administrative metadata. In general, technical metadata may describe how a document may have been created or modified. In an example of a camera, the technical metadata may include the ISO settings, color profile, size, zoom, and other camera settings. In many cases, the technical metadata may include the camera make and model number and in some cases even the manufacturer's serial number of that particular device.

Descriptive metadata may be any parameters that may describe the contents of the document. Such metadata may include titles, captions, headlines, keywords, and other information that may or may not be text based. Descriptive metadata may also include location parameters, such as a Global Positioning System (GPS) coordinates or other location description. Descriptive metadata may also include timestamps, time zone, or other time-related descriptors.

Administrative metadata may include parameters relating to how a document may be handled, such as usage rights, usage restrictions, provenance information, identity of the creator, contact information, licensor information, or other metadata.

The offline analyzer 118 may identify peculiarities between groups of documents. For example, the particular arrangement of a metadata element, such as the spelling of the element or the number of spaces between the element label and its value, may be an indicator that a document was created by a specific type of device or processed by a specific version of a software product. Such peculiarities may be examined to check for inconsistencies in the data, which may indicate fraud for example. In one such example, the metadata formatting may indicate that a specific device was used to create a document, yet the device metadata structure may be something different. In such a situation, the document metadata structure may be suspect and lead one to infer that the document had been modified or even manipulated.

The behavior of metadata parameters may be examined by an offline analyzer 118. A simple example of a behavior may be the incremental sequencing of a file name. Many devices, such as cameras and video recorders, may create filenames that are sequentially incremented. Such a behavior may be identified by examining a group of documents created by a single device and analyzing all of the available metadata parameters. Another example may be a metadata parameter that counts a number of seconds or milliseconds that a device has been on. Such parameters may be used to verify a sequence of documents or to populate a missing metadata parameter in some cases.

Both examples may be parameters that may help identify a sequence of documents produced by a device. When such a sequence does not match a timestamp identified by another parameter, there may be an indicator of fraud or other irregularity.

The document analyzer 122 may evaluate a single document or group of documents by examining metadata relating to the document or documents. The document analyzer 122 may build an expanded metadata structure, which may include additional metadata parameters than may be included in the document. The expanded metadata structure may be populated by data that may be gathered from any source, including the original metadata structure, comparisons with the metadata structures 120, or other source. When multiple documents may be analyzed together, metadata values from one document may be used to populate the metadata structure of another document.

In some cases, the metadata parameters that may populate a metadata structure may be “seed” values. The seed values may be updated during or after analysis, and may be iteratively determined in some analyses.

The expanded metadata structure may include metadata parameters that may not have been included in the original document. In some cases, the expanded metadata structure may include parameters and metadata snippets taken from the metadata structures 120, as well as from other documents within a group of documents.

Clustering analysis or other analysis may be performed on the expanded metadata structure. Such analysis may result in groups of metadata parameters that may be separate from each other. In a simple analysis of timestamps, such analysis may result in a group of metadata parameters indicating that an image may have been created at 11:35 am, and a second group of metadata parameters indicating that the same image was created at 10:35 am. A further analysis may indicate that the 10:35 am group may have been based on GPS settings, while the 11:35 am group may have been based on the device's internal clock. Because the GPS data appear to be consistent, the analysis may use the GPS-derived data as the creation time and may ignore or in other way mark or correct the other time settings to correspond to the actual time.

The document analyzer 122 may examine groups of documents. In many cases, a group of documents may have an express or implied sequence that may be found from multiple metadata parameters. The document analyzer 122 may examine each metadata parameter that behaves in a time-consistent manner, and may be able to detect irregularities when two or more metadata parameters are not consistent. For example, three images may be presented with timestamps of 12:01 am, 12:10 am, and 1:35 am. The filenames may be IMAGE001.JPG, IMAGE003.JPG, and IMAGE002.JPG. The document analyzer 122 may identify the inconsistency between the filename sequence and the timestamp sequence. The inconsistency may indicate fraud or some other abnormality.

Examination of a group of documents may include deriving some metadata from one document or subset of documents and inferring those values to other documents in the set. For example, a group of documents may include a subset of documents that came from one source and a second subset that came from a different source, or in a similar example, some of the documents may have been processed by one post processor where the others may have not.

The document analyzer 122 may operate by comparing a document's metadata structure with an expected metadata structure based on a purported provenance. The document may be received with a given provenance, and the document analyzer may construct a metadata structure from the metadata structures 120 for a document having the purported provenance. The metadata structures may be compared to identify missing or improper metadata elements. Such an analysis may evaluate the structure of the metadata and may or may not evaluate the values of the metadata. The structure of the metadata may include the parameter names, sequences, formatting of the metadata, or other elements.

The document analyzer 122 may operate by examining a document's metadata structure and attempting to reconstruct the provenance of the document by pattern matching against snippets in the metadata structures 120. Such an analysis may evaluate both the metadata structure and values in the metadata to identify similar metadata elements from the metadata structures 120.

The document analyzer 122 may begin with determining the source of a document, which is often the creator of much of the metadata content. Based on the inferred source of the document, a metadata structure from a similar or same source may be created from the metadata structures 120. A comparison of the two metadata structures may be compared to determine if any differences exist. If so, a search may be made to find metadata structures that may fit the differences. When a match is found, the document analyzer 122 may assume that a post process procedure was performed to cause the change. The process may iterate until a metadata structure may be generated that matches that of the provided document.

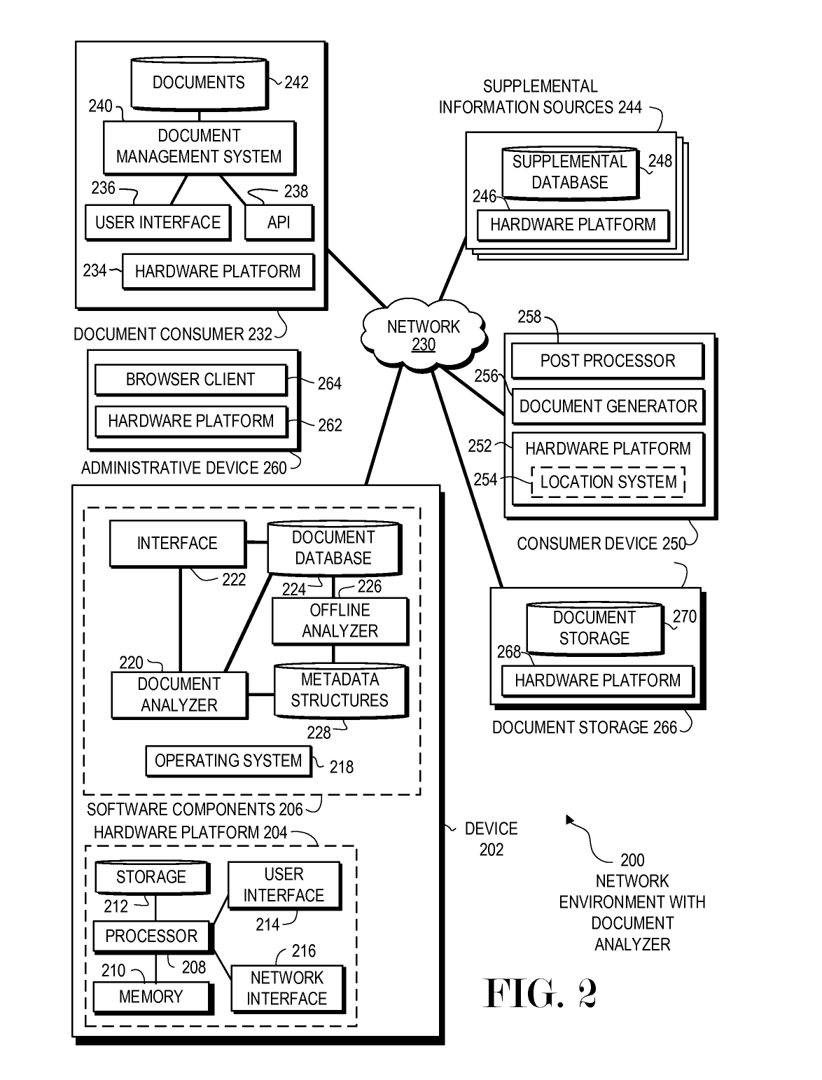

FIG. 2 is a diagram of an embodiment 200 showing components that may create, post process, store, and analyze documents. Embodiment 200 is merely one example of components of a system that may be distributed on different hardware components and platforms. In other embodiments, the various components may be implemented differently.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a device 202 that may have a hardware platform 204 and various software components. The device 202 as illustrated represents a conventional computing device, although other embodiments may have different configurations, architectures, or components.

In many embodiments, the device 202 may be a server computer. In some embodiments, the device 202 may still also be a desktop computer, laptop computer, netbook computer, tablet or slate computer, wireless handset, cellular telephone, game console or any other type of computing device. In some embodiments, the device 202 may be implemented on a cluster of computing devices, which may be a group of physical or virtual machines.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate.

A document analyzer 220 may examine documents individually or in groups and may attempt to determine time-related data about the documents. The documents may be text based documents as well as multimedia documents such as images, video, audio, and other documents. The documents may be analyzed at least in part by examining the metadata associated with the documents. Such metadata may be embedded in the document's file or may be external to the document.

An interface 222 may interact with external systems to receive documents and respond with analysis results. In many cases, the interface 222 may be an application programming interface (API) or other interface that may be accessed programmatically. In some cases, the interface 222 may be a user interface, which may be accessed through the hardware user interface 214 or through another device that communicates to the interface 222, such as using a web browser.

A document database 224 may be a database of many documents that may be analyzed using an offline analyzer 226. The offline analyzer 226 may perform clustering analysis or other analysis to identify metadata structures 228 from the documents.

The document database 224 may include large numbers of documents, where the documents may or may not be related in some fashion.

The metadata structures 228 may include snippets or subsets of metadata that may have definable characteristics or from which inferences may be drawn. For example, a subset of metadata that may have specific characteristics may be an artifact of a specific type of camera used to generate an image. The subset may be used to match against an image to determine if the image was likely to have been created by the same type of camera.

The metadata structures 228 may be used to verify an assumed provenance of a document by comparing a metadata structure of a document to the expected metadata structure that the provenance may imply. The expected metadata structure may be constructed from the metadata structure.

The document analyzer 220 may provide analysis of various time related aspects of a document. In many scenarios, the time and date of creation of a document may be useful, as well as time and date of any subsequent activities with the document. In an example of an image, the time of creation may be relied upon for business or legal transactions, such as an insurance claim or as evidence in a police investigation. In another such example, the time of creation may be useful in organizing a user's photos in a library.

The network 230 may connect the device 202 to other devices and services.

A document consumer 232 may illustrate a system that may access the document analyzer 220 as a service. An example of a document consumer 232 may be a police detective system that may process documents collected as evidence, and such a system may transmit documents or the metadata of the documents to the document analyzer 220 for timestamp verification. Another example of a document consumer 232 may be a tool used by insurance investigators and claims processors whose system may transmit documents or metadata to the document analyzer 220 for fraud detection. Yet another example of a document consumer 232 may be a photo management or other document management service that may send documents or document metadata to the document analyzer 220 to determine an accurate timestamp, which may be used for organizing the documents.

The document consumer 232 may have a hardware platform 234 on which a user interface 236 or application programming interface (API) 238 may operate. A document management system 240 may be any type of application that may manage various documents 242. In some cases, the document management system 240 may be the primary focus of an application, such as an electronic evidence management system used by police. In other cases, the document management system 240 may be a feature or capability of a larger system that may handle documents as a secondary focus.

Supplemental information sources 244 may be any type of external data source that may be useful to augment a metadata analysis of a document. The supplemental information sources 244 may have a hardware platform 246 on which a supplemental database 248 may operate.

Examples of supplemental information sources 244 may include geographical databases, which may be used to extract time zone information, for example. Another example may be a database of camera information or image post processing data that may be used to fill in missing or unpopulated metadata elements when analyzing images. These are merely two examples of such information sources and uses, and many more are possible.

A creation device 250 may be any device that may create or post process a document. The creation device 250 may be a computer, camera, video recorder, data gathering device, appliance, or any other platform that may create or post process a document that may be analyzed by a document analyzer 220.

A creation device 250 may have a hardware platform 252 which may include a location system 254. The location system 254 may be any mechanism by which the location of the device 250 may be determined, one example of which may be a GPS receiver. The creation device 250 may have a document generator 256 and also may include a post processor 258.

An administrative device 260 may be a device through which the device 202 or other devices may be managed. A typical administrative device 260 may include a hardware platform 262 on which a browser client 264 may operate. The browser client 264 may connect with and provide a user interface to the device 202, the document consumer 232, or other device.

A document storage system 266 may be a device that stores and retrieves documents. In many cases, a document storage system 266 may generate metadata relating to electronic documents, such as a timestamp when the document was received, a creation date, modification date, modification history, or other metadata. These metadata may be stored in the file or may be separately stored in a file management system. The document storage system 266 may have a hardware platform 268 on which a document storage 270 may execute.

A document gatherer system 272 may be a service that may gather samples of documents from a wide range of sources. The gathered documents may be used to populate the document database 224. A document gatherer system 272 may have a web crawler, social network crawler, or other mechanism that may gather documents for analysis. In many cases, publically available documents may be used to populate a document database 224 to generate metadata structures 228.

The document gatherer system 272 may have a hardware platform 274 on which a document gatherer application 276 may execute.

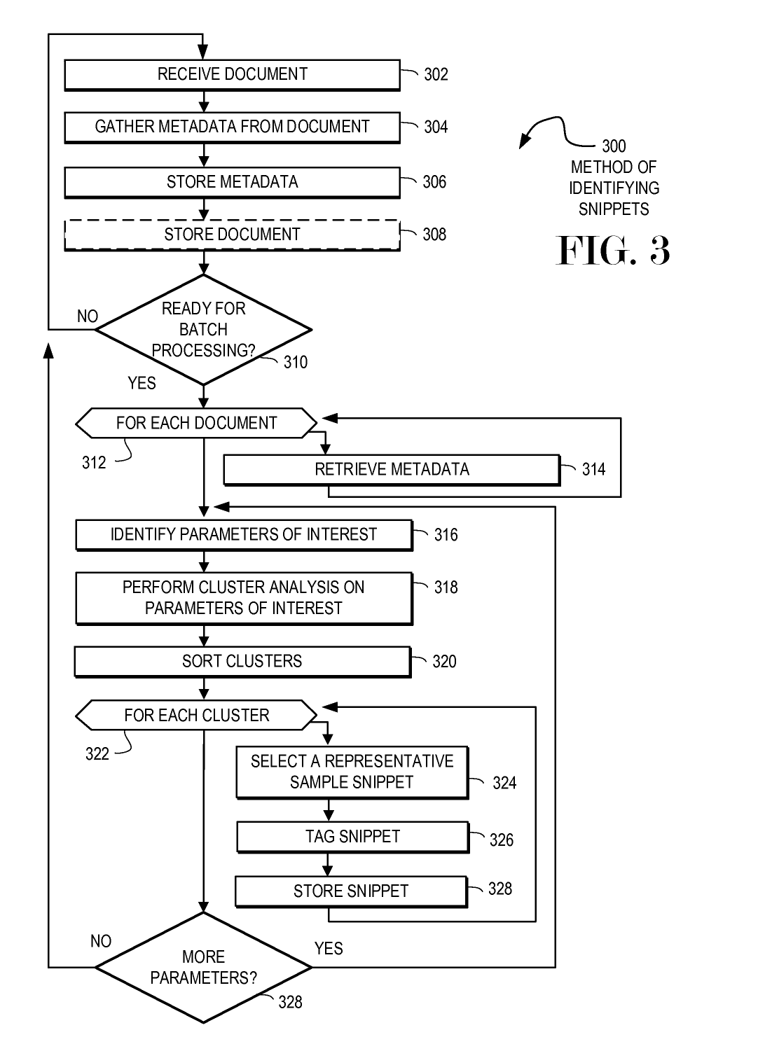

FIG. 3 is a flowchart illustration of an embodiment 300 showing a method for identifying representative metadata snippets that can be used to evaluate metadata structures. The metadata snippets may be identified from cluster analysis or other analysis of groups of documents. In many cases, the metadata snippets may include human input or analysis that may assist in tagging the metadata snippets.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

Embodiment 300 may illustrate a process that may identify and tag metadata snippets or segments. The metadata segments may represent a point of commonality between documents, and when present or missing from a document's metadata, may represent inferences that may be drawn from the metadata.

Embodiment 300 operates to collect and store document metadata in blocks 302 through 310. In this process, a document may be received in block 302, the metadata may be identified in block 304, and the metadata may be stored in block 306. The document may optionally be stored in block 308. Until the system may be ready for batch processing in block 310, the process may loop back to block 302.

The process of blocks 302 through 310 may represent a process that may receive documents from various sources. Some systems may have a document gatherer system that may crawl websites, databases, or other sources to identify documents to process.

The metadata that may be gathered in block 304 may include metadata embedded in a document file as well as metadata that may describe the history or provenance of a document. The history or provenance metadata may or may not be embedded in the document file and may be provided by a document gatherer, file system, database, or other source external to the document file.

Batch processing of the documents may begin in block 310. Embodiment 300 illustrates this portion of the process as batch processing merely because the analysis techniques often use comparisons across multiple documents. Such analyses can include primary component analyses, clustering analyses, and other techniques.

For each document in block 312, the metadata for the document may be retrieved in block 314.

Parameters of interest may be identified in block 316. In some cases, a predefined group of parameters may be provided. Some such parameters may be identified by a human expert that may identify parameters based on expert opinion, and such parameters may be defined ahead of time or contemporaneously with the analysis of embodiment 300.

Parameters of interest may be identified by automated analyses in some cases. For example, a set of document metadata may be analyzed using primary component analysis to identify those metadata parameters that have more effect on identifying documents. In some cases, a combination of automated and human selection may be performed to identify parameters of interest.

Cluster analysis may be performed using the parameters of interest in block 318. The result of the cluster analysis may be several clusters, which may be sorted in block 320. The sorting may rank the clusters in order of size, density, distribution, or other metric.

The clustering analysis may result in a cluster centroid and a distance measurement between the centroid and various members of the cluster. The distance measurement may be used as a confidence indicator that a parameter may be a member of the cluster, especially when compared to the distance between centroids of clusters.

For each cluster in block 322, a representative sample metadata snippet may be selected in block 324. The snippet may be tagged in block 326 and stored in block 328.

The snippet or sample tagging of block 326 may include inferences that may be drawn from the snippet. The inferences may be provided by a human analyst or may be automatically inferred from the data. An example tag may identify a snippet of metadata as being generated by a specific brand and model of a camera, for example.

The tagging of block 326 may include a statistical measure of the confidence of the tagging. The confidence may be calculated by the density, spacing, distribution, or other measurements of the data clusters. In many cases, the confidence may have calculable statistical meaning.

In block 328, if additional parameters are to be analyzed in block 328, the process may return to block 316 to select more parameters. If no more parameters are to be analyzed in block 328, the process may return to block 302.

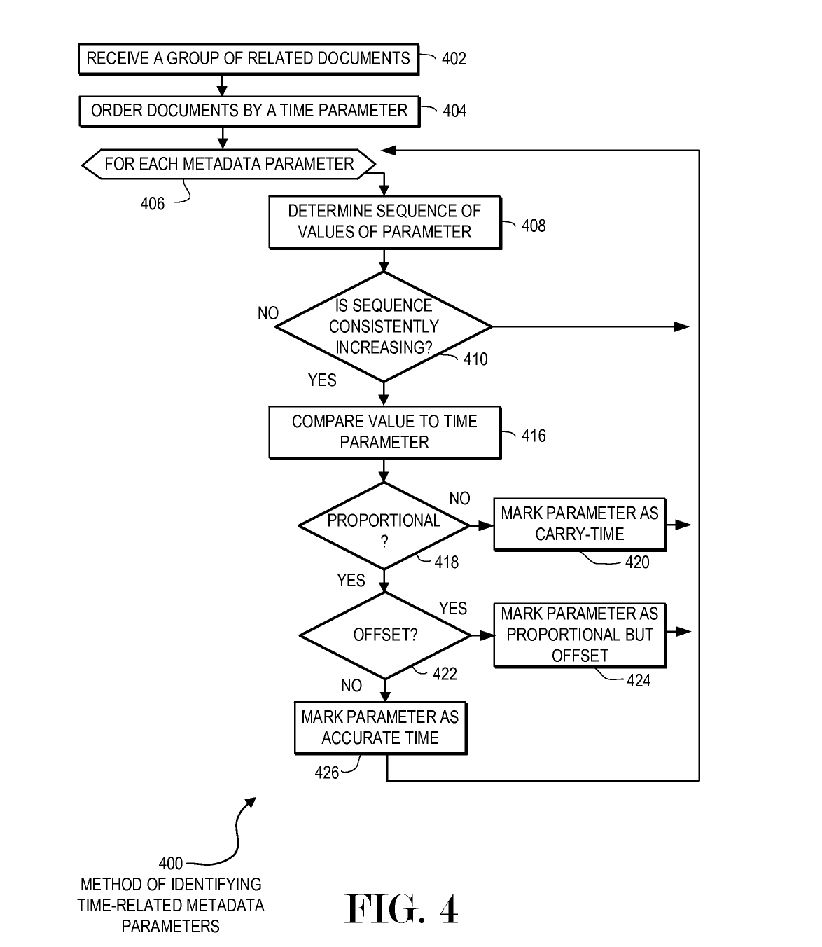

FIG. 4 is a flowchart illustration of an embodiment 400 showing a method for identifying metadata parameters that may track time in some fashion.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

In many documents, there may be parameters that may reflect time directly, such as the creation timestamp, editing timestamp, saving timestamp. However, other parameters may indirectly indicate time, such as a sequential numbering of filenames, a parameter that reflects the number of seconds a device has been operating, or other parameters that may not have been intended to represent time. Such parameters may be useful in helping reconstruct a timeline of multiple documents as well as to detect inconsistencies within the metadata. Inconsistencies may be flagged as fraud or otherwise identified as suspect.

A group of documents may be received in block 402. The group of documents may be related in some manner. In some cases, documents from the same source may be used, documents that may have undergone the same post processing, or some other common factor.

The documents may be organized by a time parameter in block 404. In some cases, the organization may be automated while in other cases a human may curate the document group in a time sequence.

For each metadata parameter in the documents in block 406, a sequence of the values of the parameter may be determined in block 408. If the sequence is not consistently increasing or decreasing in block 410, the parameter may not exhibit a time-related behavior.

When the sequence is either increasing or decreasing in block 410, the value of the parameter may be compared to a time parameter in block 416. If the parameter increases or decreases with time but is not proportional to the time parameter in block 418, the parameter may be marked as a carry-time parameter in block 420.

If the parameter is proportional to the time parameter in block 418 but is offset from but not equal to the time parameter in block 422, the parameter may be marked as a proportional but offset time parameter in block 424.

If the parameter is proportional to the time parameter in block 418 and is not offset from the time parameter in block 422, the parameter may be marked as an accurate time parameter in block 426. The term “accurate” in this context is not meant to imply that the value of time is accurate, but that the parameter behaves like the time parameter used to arrange the group of documents.

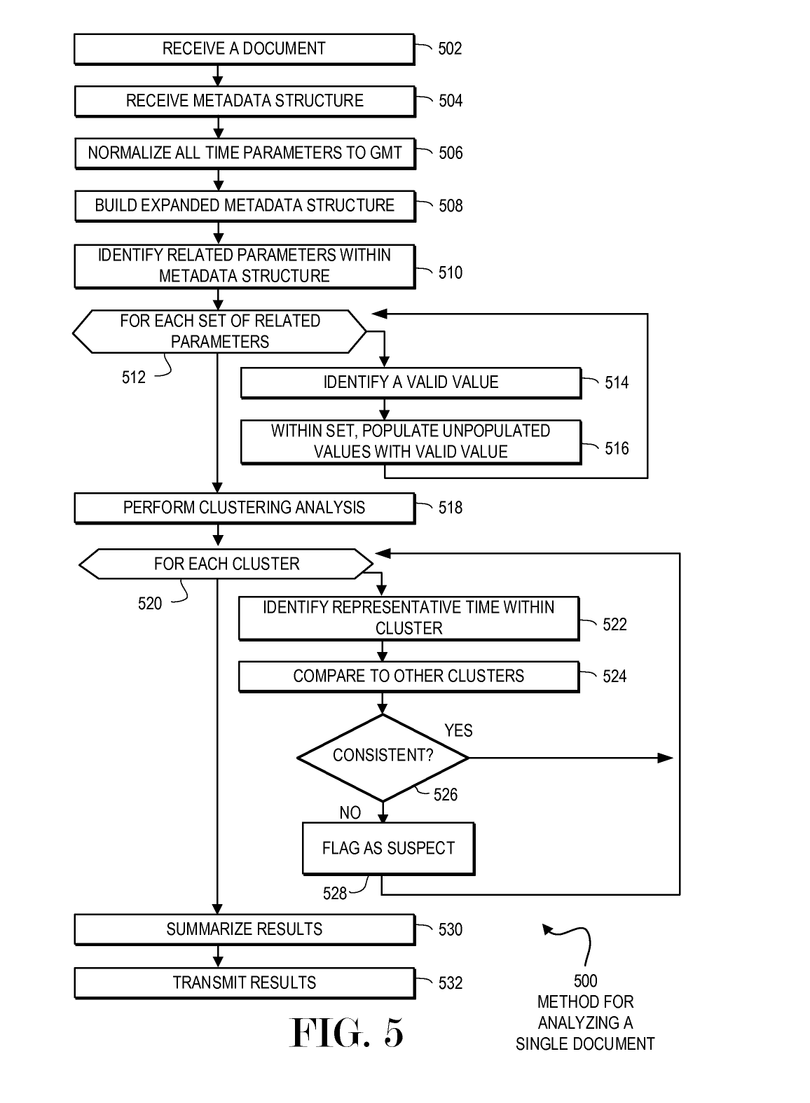

FIG. 5 is a flowchart illustration of an embodiment 500 showing a method for analyzing a single document. Embodiment 500 is one method that may be used by a document analyzer to detect inconsistencies in the metadata of a document. The document may be any type of electronic document, including images, videos, text based documents, audio documents, or any other electronic document.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

Embodiment 500 is one method for detecting inconsistencies in a document's metadata. The analysis populates an expanded metadata structure, then used clustering analysis to identify groups of metadata parameters. From the clustering analysis, anomalies within the data may be made more apparent and become easier to detect.

A document may be received in block 502 as well as a metadata structure in block 504. The metadata structure in block 504 may be extracted from the document, and may include external metadata that may be supplied separately from the document.

All of the time parameters may be adjusted to reflect Universal Coordinated Time, Greenwich Mean Time, or some other time standard in block 506.

An expanded metadata structure may be created for the document in block 508. The expanded metadata structure may include several metadata parameters that may not have been included in the metadata structure received with the document.

In one mechanism to expand the metadata structure, a document type may be determined and metadata parameters related to the document type may be added. For example, an image document may have a set of parameters added for camera type, focal length, shutter speed, white balance adjustment, and other camera related parameters. An image may also have parameters for local time of day, weather conditions, outdoor temperature, and other parameters.

The expanded metadata structure may be populated by outside sources in some cases. In the example of a local time of day and weather related conditions, the location of the image may be gathered from GPS coordinates, and a look up to a weather database may estimate the weather conditions and local time of day may also be determined. These metadata parameters may be useful in some circumstances to reason about the image.

For example, a local time of day and weather related parameters may further be used to estimate the amount of sunshine at the time and location that the image was taken. These parameters may be compared to the image's camera settings, such as exposure, ISO settings, and other settings to determine whether an image appears to be consistent with an image taken indoors or outdoors.

Within the expanded metadata structure, sets of related parameters may be identified in block 510. For each set in block 512, a valid value may be determined in block 514 and unpopulated parameters within the set may be populated with the representative value in block 516.

The representative value of a group of parameters may be determined by examining the group of related parameters to find a parameter that has a valid value. In some cases, the representative value may be determined by querying an external data source.

Clustering analysis may be performed across the expanded and populated metadata structure in block 518. In many cases, the clustering may attempt to organize the metadata structure with respect to time related parameters.

For each cluster in block 520, a representative time within the cluster may be identified in block 522 and compared to other clusters in block 524. When the comparisons are consistent in block 526, the process may continue to another cluster in block 520. When the comparisons indicate inconsistency in block 526, the document may be flagged as suspect in block 528.

The consistency analysis of block 526 may be any type of comparison between two or more groups. For example, a time parameter recorded from a GPS positioning system may be compared to a time parameter retrieved from a device's internal clock. When the difference may be a matter of minutes, the difference may be attributed to an incorrect setting on the device.

Some groups of parameters may have time and date parameters that may be substantially or statistically inconsistent with the other groups. For example, a time artifact that may be present due to a modification of a document many days after creation may indicate that the document may have been changed from the original.

The consistency analysis may include provenance analysis. Examples of provenance analysis may be found in embodiments 700 and 800 later in this specification.

The results of the clustering and consistency analysis may be summarized in block 530 and transmitted in block 532.

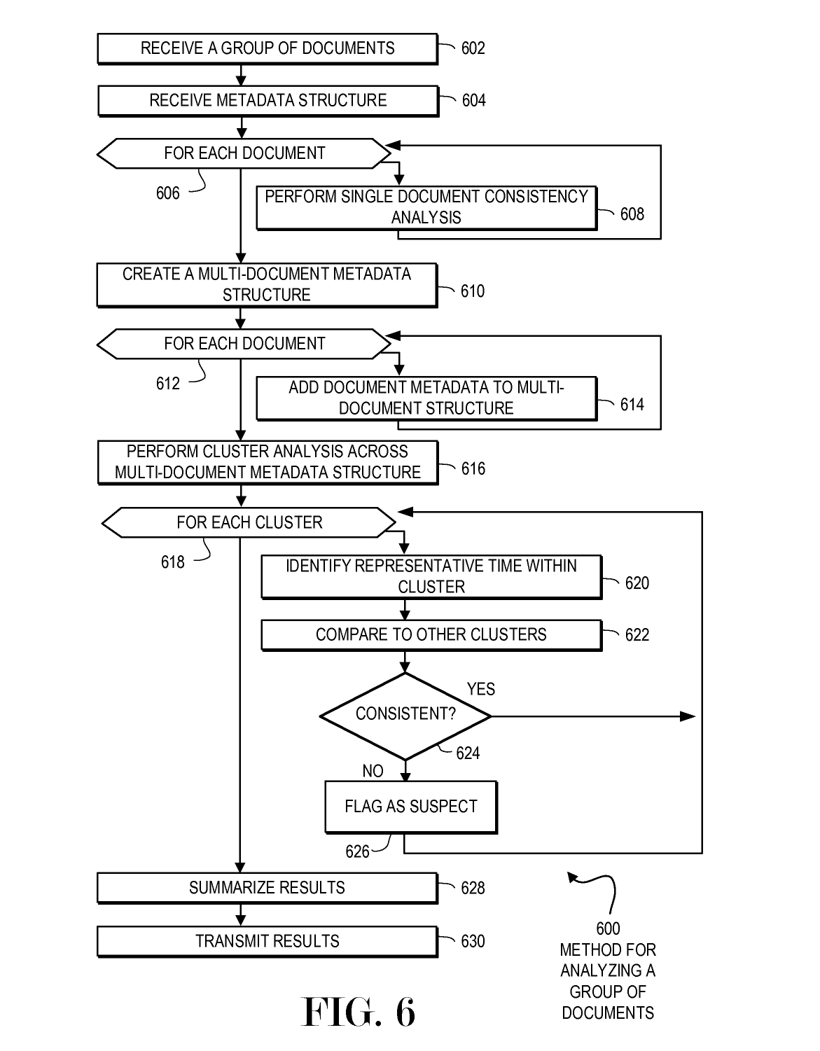

FIG. 6 is a flowchart illustration of an embodiment 600 showing a method for analyzing multiple documents. Embodiment 600 is one method that may be used by a document analyzer to detect inconsistencies in the metadata of a group of documents. The documents may be any type of electronic document, including images, videos, text based documents, audio documents, or any other electronic document.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

Embodiment 600 may perform a single document analysis for inconsistencies on each document, then may perform a clustering analysis of the metadata aggregated from all of the documents.

When analyzing a group of documents, some inconsistencies may be detectable due to artifacts of carry-time parameters or other parameters that may not have been intended to represent time. The inconsistencies in the behavior of parameters over a group of documents may help identify individual documents or sets of documents that may not be consistent with the others.

The group of documents may have at least one common characteristic. The characteristic may be a common user, a common device, a common device type, a common device model, a common post-creation post processing service, a common transmission network, a common storage system, a common document type, a common metadata parameter, a common metadata parameter value, or any other common characteristic.

A group of documents may be received in block 602, along with metadata in block 604. The metadata in block 604 may be extracted from the documents and may include external metadata supplied from a different source.

For each document in block 606, a single document consistency analysis may be performed in block 608. An example of such a single document consistency analysis may be found in embodiment 500.

A multi-document metadata structure may be created in block 610 to hold all of the metadata from the various documents. For each document in block 612, the document's metadata may be added to the metadata structure. The document's metadata may be an expanded metadata structure that may result from a single document consistency analysis.

A cluster analysis may be performed across the multi-document metadata structure in block 616, and several clusters may be identified.

For each cluster in block 618, a representative time value within the cluster may be identified in block 620 and a comparison may be made to other clusters in block 622. When the comparison is consistent in block 624, the process may return to block 618. When the comparison may be inconsistent in block 624, the cluster may be flagged as suspect in block 626.

The consistency analysis of block 624 may include many individual tests, algorithms, heuristics, and other mechanisms for determining consistency. In one example, the consistency analysis may include examining whether various carry-time parameters behave consistently across a group of documents.

One form of consistency analysis may be provenance analysis. Examples of provenance analysis may be found in embodiments 700 and 800 later in this specification.

The results may be summarized in block 628 and transmitted in block 630.

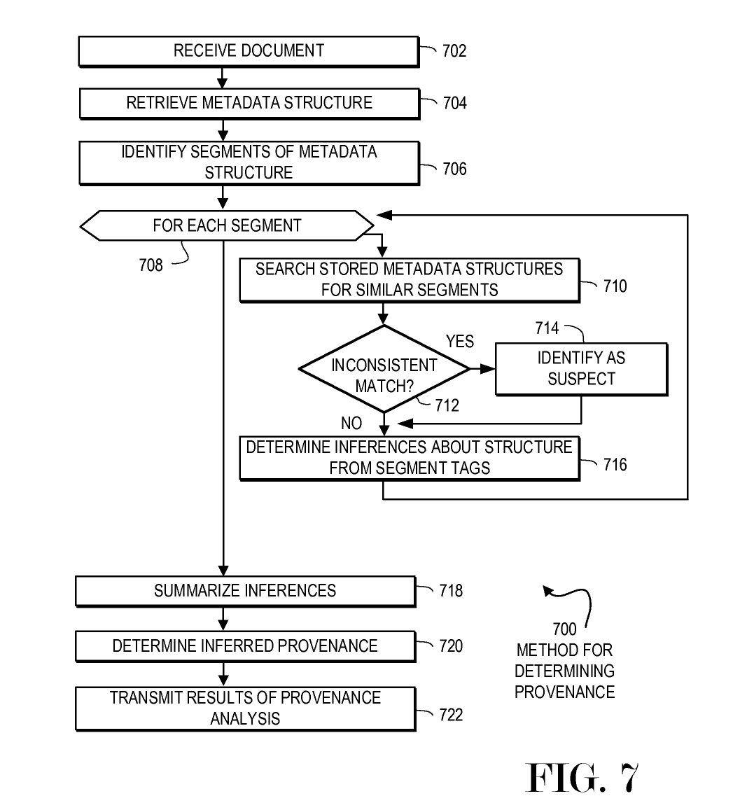

FIG. 7 is a flowchart illustration of an embodiment 700 showing a method for determining provenance of a document. Embodiment 700 is one way that metadata structures generated in embodiment 300 or other mechanisms may be used to estimate the provenance of a document.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

Document provenance may be an indicator of authenticity or reliability of a document. The inferred provenance of a document may indicate that a document has not been altered and therefore may be believed. When a document's inferred provenance is different from its purported provenance, an inconsistency may arise and the document may be suspected as fraud.

A document may be received in block 702, along with a metadata structure in block 704.

Segments within the metadata structure may be identified in block 706. The segments may be blocks of parameters that may be related in some fashion. For each segment in block 708, a search may be performed for similar segments in block 710 from a database of metadata structures. An example of such a database may be the metadata structures 120 of embodiment 100.

When comparing the document's metadata segment with stored metadata structures and the match is consistent in some manner, the segment may be identified as suspect in block 714.

Inferences about the segment may be made in block 716. An inference may be determined from a tag or other information associated with the matching segment retrieved from a metadata structures database.

The inferences may be summarized in block 718 and an inferred provenance may be determined in block 720. The results of the provenance analysis may be transmitted in block 722.

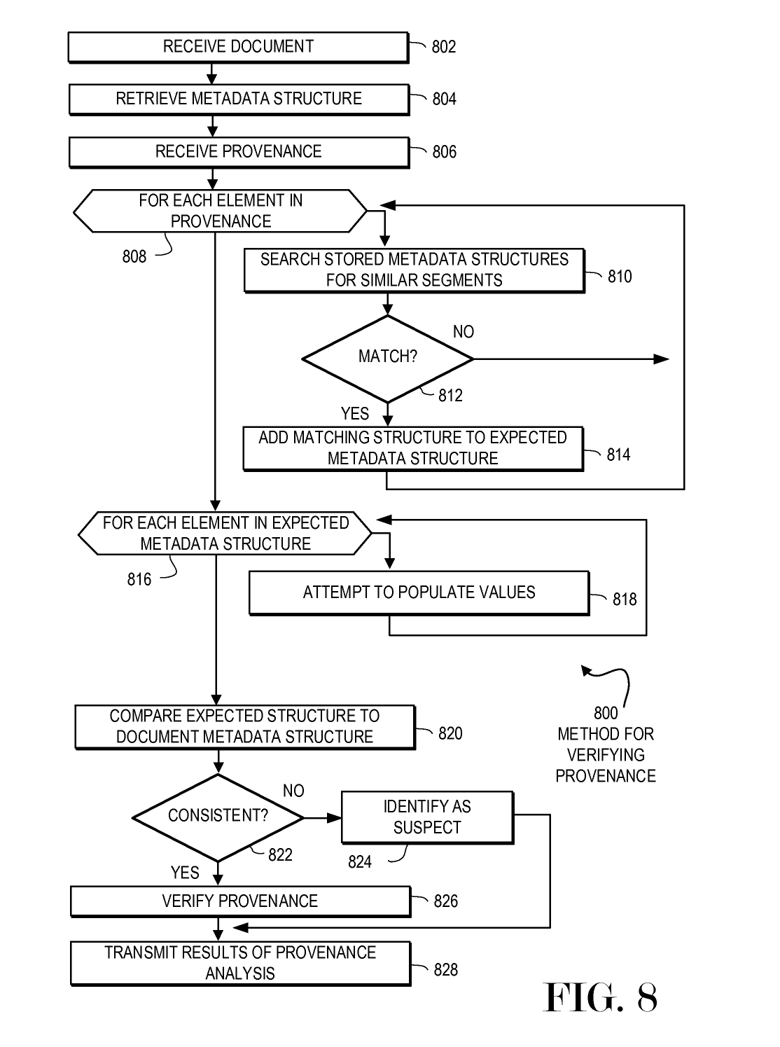

FIG. 8 is a flowchart illustration of an embodiment 800 showing a method for analyzing provenance of a document. Embodiment 800 is one way that metadata structures generated in embodiment 300 or other mechanisms may be used to estimate the provenance of a document.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified form.

Embodiment 800 may illustrate a manner of verifying a provenance. Embodiment 800 may attempt to construct an expected metadata structure for a document based on a given provenance, then may compare the expected metadata structure with actual metadata structure for a document.

A document may be received in block 802 along with its metadata structure in block 804. A purported provenance may be received in block 806. The purported provenance may include a history of the document, such as the times and dates of document creation, modification, storage, and other post processing. The purported provenance may include the devices and settings used to create, handle, and process the document, as well as any other information that may be populate a metadata structure describing the document.

For each element in the purported provenance in block 808, a search may be made for metadata structures in a metadata structure database. When a match may be made in block 812, the matching structure may be added to an expected metadata structure. If no match is determined in block 812, the process may continue to the next provenance element in block 808.

Each element in the expected metadata structure may be analyzed in block 816. An attempt may be made in block 818 to populate values for the expected values. In many cases, some values may not be able to be determined. In some cases, some values may be determined from the provenance. For example, a document purported to be created on a personal computer using a specific word processing program on a certain date may have several metadata values that may be inferred or assumed from the provenance. In another example, a video document purported to have been created outdoors at a specific location and at a specific time may have lighting parameters inferred.

The expected metadata structure may be compared to the document's metadata structure in block 820. When the two metadata structures are not consistent in block 822, the document may be flagged as suspect in block 824. When the metadata structures are consistent with each other in block 822, the provenance may be verified in block 826. The results of the provenance analysis may be transmitted in block 828.

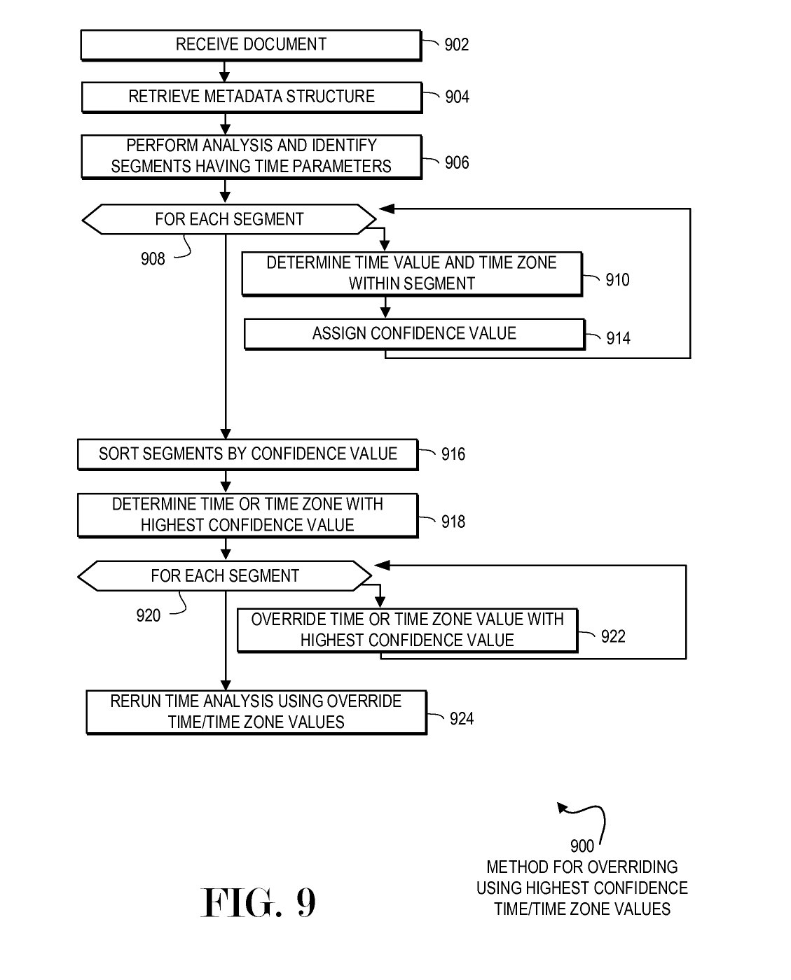

FIG. 9 is a flowchart illustration of an embodiment 900 showing a method for overriding time or time zone parameters using higher confidence time or time zone parameters.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principals of operations in a simplified

Embodiment 900 may illustrate one sequence for populating and overriding values within a metadata structure. Such a method may be used by a document analyzer to determine time-related or other metadata parameters.

Time zone information may be useful to determine the offset of a time value from a standard time, such as Universal Coordinated Time. Such an offset may be useful to coordinate time values that may originate from different sources. In some cases, the inconsistencies between time values may be due to time zone offsets, and when the parameters are reset to a common time offset, the differences or inconsistencies may become minor.

A document may be received in block 902, and the metadata for the document may be retrieved in block 904.

An analysis may be performed in block 906 to identify metadata segments having time parameters. In many cases, such an analysis may be performed after generating an expanded metadata structure that may include unpopulated parameters. In some used, the analysis on block 906 may be performed after populating the unpopulated parameters, while in other uses, the analysis may be performed before populating the unpopulated parameters.

For each segment in block 908, a time value and time zone value may be determined within the segment. A time zone value may be determined by analyzing a metadata parameter that may indicate a location, such as a “place-carry” parameter. For example, a user may annotate an image with “Paris, France”. Based on that annotation in the metadata, a time zone inference may be made.

The consistency of the data and other factors may be used to assign a confidence value in the time or time zone parameter in block 914. The confidence value may be determined using a heuristic or other mechanism that may assign higher confidence values to some types of time or time zone determinations and lower confidence values to others. In the example above, a user's manually entered tag of “Paris, France” may be a high confidence indicator of the location.

The segments may be sorted by confidence value in block 916 and the time or time zone value with the highest confidence value may be determined in block 918.

For each segment in block 920, the time or time zone parameter in the segment may be overridden by the value selected in block 918. The time analysis may be re-run in block 920 using the overridden time or time zone values.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principals of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed on at least one computer processor, said method comprising:
receiving a metadata structure from a digital document, said metadata structure comprising at least some predefined values;
analyzing said metadata structure to identify time-related parameters;
performing a clustering analysis of said time-related parameters;
determining a predicted value for a first time-related parameter, said predicted value being determined from said clustering analysis;
comparing said predicted value to a first predefined value received in said metadata structure to determine a fraud likelihood for said digital document; and
reporting said fraud likelihood for said digital document.

2. The method of claim 1 further comprising:
grouping said time-related parameters into at least two groups.

3. The method of claim 2, one of said at least two groups being one of a group composed of:
document creation time parameters;
document modification time parameters;
time parameters being derived from internal device settings;
time parameters being derived from Global Positioning System parameters;
time parameters being derived from external device settings;
time parameters originating from a first time source; and
time parameters being carry-time parameters.

4. The method of claim 2 further comprising:
populating a second time-related parameter in a first group with a time value derived from a third time-related parameter in said first group.

5. The method of claim 4 further comprising:
said first predicted value being a predicted value for said clustering analysis applied to a first group, said first predefined value being within said first group.

6. The method of claim 3 further comprising:
said predicted value being a center of a first group and said first predefined value being a metadata parameter associated with a second group.

7. The method of claim 1 further comprising:
capturing additional metadata from a secondary source; and
adding said additional metadata to said metadata structure.

8. The method of claim 7, said secondary source being a second metadata structure from a second digital document.

9. The method of claim 8, said second digital document being related to said digital document.

10. The method of claim 7, said secondary source being a service that processed said digital document.

11. The method of claim 10, said service being at least one of a group composed of:
a storage service; and
a transmission service.

12. The method of claim 1 further comprising:
identifying a first device from a second predefined value in said metadata structure; and
adding a predefined metadata substructure to said metadata structure based on said first device.

13. The method of claim 12, said first device being at least one of a group composed of:
a creating device; and
a modifying device.

14. The method of claim 1 further comprising:
identifying a first document type from at least one of said predefined values in said metadata structure; and
adding a predefined metadata substructure to said metadata structure based on said first document type.

15. The method of claim 14, said first document type being one of a group composed of:
an image;
an audio file;
a video file;
a document comprising displayable text;
a database document; and
an executable document.

16. The method of claim 1, said metadata structure comprising a plurality of unpopulated items.

17. The method of claim 16 further comprising:
adding at least one added parameter to said metadata structure prior to said performing said clustering analysis.

18. The method of claim 17, said added parameter being derived from analyzing a second metadata structure from a second digital document.

19. The method of claim 17, said added parameter being at least one of a group composed of:
a calculated creation timestamp;
a calculated modification timestamp; and
a calculated fraud likelihood parameter.

20. The method of claim 1 further comprising:
receiving a plurality of metadata structures from a plurality of related digital documents;
analyzing said plurality of metadata structures to identify a second metadata parameter, said second metadata parameter behaving like a time-related parameter, said second metadata parameter being a carry-time parameter; and adding said second metadata parameter to as one of said time-related parameters.
